(19) United States
(12) Patent Application Publication
(10) Pub. No.: US 2004/0200753 A1
(43) Pub. Date: Oct. 14, 2004

(54) Assembly of at least two container parts, as well as container part and method for fabricating a container

(76) Inventor: Arie W Beekman, Hoek (NL)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/487,399

(22) PCT Filed: Sep. 3, 2002
(86) PCT No.: PCT/US02/27982

Related U.S. Application Data
(60) Provisional application No. 60/323,748, filed on Sep. 19, 2001.

(51) Int. Cl. B29C 65/00

(52) U.S. Cl. 206/509; 264/248; 264/249

(57) ABSTRACT

An assembly (1) comprising at least a first and a second container part (2′, 2″) each comprising a thermoplastic material, wherein the first container part (2′) and the second container part (2″) are joined, wherein the first container part and the second container part each comprises a wall (3) and a rim (4) which rim (4) is substantially closed in itself, wherein the rim (4) of the first container part (2′) and the rim (4) of the second container part (2″) are welded against each other, wherein the assembly (1) further comprises a cover (11, 11′, 11″) which defines together with an inner side of the wall (3) of the first container part (2′) and an inner side of the wall (3) of the second container part (2″) a channel for protection of an inner space of the joined first container part (2′) and second container (2″) part against thermoplastic material that may protrude from the welded rims (4), wherein the inner side of the wall of the first container (2′) part and the inner side of the wall of the second container (2″) part by themselves and without the cover (11, 11′, 11″) don not define a cavity near the rims (4).

### CROSS REFERENCE STATEMENT

This application claims the benefit of U.S. Provisional Application No. 60/323,748, filed Sep. 19, 2001.

### TECHNICAL FIELD

The invention relates to an assembly comprising two container parts which are made of a thermoplastic material. The invention further relates to a container comprising joined thermoplastic container parts. The invention also relates to a method for fabricating a container. More particularly, this container is suitable for containing a liner bag filled with e.g., pressurized gas, liquids or both.

### BACKGROUND ART

Thermoplastic containers are often used for storage and transport of liquids. In order to fabricate a container out of a thermoplastic material, wall parts, preferably two halves of the container, are produced by for instance injection molding. These wall parts each have a rim. Two rims are subsequently welded against each other to form a joint. Hereto, thermoplastic material is heated at a contact surface of at least one of the rims, for instance by a hot plate or friction which may be generated by rapidly moving two contact surfaces against each other. Once a certain elevated temperature is reached the thermoplastic material at the contact surface becomes soft. By pressurizing the rims against each other this soft material welds the container parts together. During the welding the softened thermoplastic material may be squeezed away from the contact surfaces of the joining rims. This material solidifies outside the area of the joined rims and forms so-called burrs. These burrs do not contribute to the joint or strength thereof. Apart from negative aesthetic effects, burrs which protrude towards the inner side of the container may in the use of the container cause problems such as puncture of liners or liner bags held in the container.

EP 0 687 547 discloses a container produced by welding two nylon halves against each other. These halves each have been designed to prevent burrs entering the inner space of the container. Hereto, the joined rims comprise a burr holding chamber which is formed between the joined contact surfaces, the rims, and the inner wall of the container. Softened nylon material squeezed away from the pressurized contacting surfaces forms a burr upon solidification. This burr will fall or be contained in the burr holding chamber. This prevents the burrs from entering the inner space of the container. This burr holding chamber is in alignment with the inner wall of the container, or in other words forms a cavity within the joined walls of the container near the welded rims, and forms as such a serious weakness of that wall. The impact resistance and burst pressure of this container is reduced in comparison to those of a container with a wall which is free from such a joint. As a result, the container is not suitable for containing pressurized fluids, or liner bags containing fluids with pressurized gas.

Accordingly, it is an object of the invention to provide an assembly of thermoplastic container parts with a welded joint between the container parts without the presence of a weak spot in the joined parts.

It is another object of the invention to provide an assembly of container parts which are welded against each other and by which an inner space of the welded container parts is protected against burrs of thermoplastic material.

It is a further object of the invention to provide an assembly of container parts which is joined by hot plate welding or by friction welding.

It is a further object of the invention to provide a container suitable for containing pressurized fluids.

It is a further object of the invention to provide a container suitable for containing a liner bag.

It is a further object of the invention to provide a container suitable for containing a liner bag filled with liquids, a pressurized gas or liquids containing a dissolved gas.

It is another object of the invention to provide an assembly of container parts which are produced by injection molding.

These and other objects may be achieved by some of the embodiments or preferred embodiments described hereinafter.

### DISCLOSURE OF THE INVENTION

In accordance with the invention there is provided an assembly comprising at least a first and a second container part each comprising a thermoplastic material, wherein the first container part and the second container part are joined, wherein the first and second container part each comprises a wall and a rim which is substantially closed in itself, wherein the rim of the first container part and the rim of the second container part are welded against each other, wherein the assembly further comprises a cover which defines together with an inner side of the wall of the first container part and an inner side of the wall of the second container part a channel for protection of an inner space of the joined first container part and second container part against thermoplastic material that may protrude from the welded rims, wherein the inner side of the first container part and the inner side of the second container part by themselves and without the cover do not define a cavity near the welded rims.

According to a further embodiment the invention provides a method for fabricating a container comprising the steps of:

providing a first container part and a second container part each comprising thermoplastic material and each comprising a wall and a rim which is substantially closed in itself and providing a cover;

subjecting at least one rim of the first container part or of the second container part to a treatment to soften thermoplastic material at the rim;

arranging the first container part and the second container part such that the rim of the first container part and the rim of the second container part contact each other while the thermoplastic material at at least one rim is softened and while the cover is in contact with at least an inner side of a wall of the first or second container part;

applying pressure so that the rim of the first container part and the rim of the second container part are pressed together to form a joint, wherein softened thermoplastic material is squeezed inwardly from the welded joint into a channel defined by the cover and the inner side of the wall of the first container part and the inner side of the wall of the second container part, wherein the inner side of the wall of the first container part and the inner side of the wall of the second container part by themselves and without the cover do not define a cavity near the rims.

The present invention offers the advantage that the inner space of the container, that is the space in which a content of the container will be placed, is free from welding burrs. A liner bag filled with pressurized gas, a liquid, or both can be held in the container without risking a puncture of the liner bag due the presence of a burr in the inner space of the container. Further, it has the advantage that the inner space of the container is free from irregularities which has a positive effect on the cleanability of the container before and after use.

The absence of a cavity near the welded rims at an inner side of the container, and thus in the continuing walls across the welded rims of the joined parts, ensures that the burst pressure of the container will not be reduced due to a cavity in that part of the internal wall. The burst pressure is the internal pressure at which the container starts to crack or burst.

### BRIEF DESCRIPTION OF THE DRAWINGS

FIG. 1 shows schematically a partial cross-section of two container parts of a first embodiment according to the invention before welding;

FIG. 2 shows schematically a partial cross-section of the two container parts of FIG. 1 after joining by welding;

FIG. 3 shows schematically a cross-section along a plane A-A of joined rims according to the invention;

FIG. 4 shows schematically a partial cross-section of two joined container parts as a further embodiment according to the invention;

FIG. 5 shows schematically a partial cross-section of two joined container parts according to another embodiment according to the invention;

FIG. 6 shows schematically a cross-section of a container according to the invention;

FIG. 7 shows schematically a top view of a container of which a cross-section along I-I is shown in FIG. 6.

### DETAILED DESCRIPTION OF THE INVENTION

In a preferred embodiment, the cover comprises a separate part with respect to the joined first and second container parts. This separate part may for instance comprise one strip with two peripheral edges, wherein at least one of the peripheral edges is in contact with an inner side of the wall of the first or second container part. At least one inner wall of the first and second container parts, and preferably both inner walls, may comprise a shoulder or recess for support of the strip. According to this embodiment, the strip is a separate part and not an integral part of the container parts. The strip can be made of any material such as metal or thermoplastic material. The strip may be an elongated strip that may be preformed or formed, for example by bending, into a shape such that is suitable for use as a cover, such as a ring, oval or ellipse shape. The strip when so shaped is positioned in contact with one of the inner sides of the wall of a first container part prior to arranging the second container part against it for forming the welded joint.

In another embodiment, the cover comprises an integral part of the first container part or the second container part. In this case, the integral part may comprise a strip. This embodiment provides for one cover attached to either the first or second container part. Said cover or strip is preferably of a tapered shape, with its thickness becoming smaller as it further extends from the container part of which it is an integral part. Said cover or strip extends preferably so as to approach or contact the inner wall of the other container part, at least during use conditions.

In an alternative embodiment, the cover comprises a first and a second cover part wherein the first cover part is an integral part of the first container part and the second cover part is an integral part of the second container part. In particular, the first part comprises a first strip and the second part comprises a second strip. Preferably, the first and the second strip contact or nearly contact each other. Such contact or near contact may be in the plane of the welded joint or outside such a plane. The first and second strip may be abutting each other or may be extending so as to partially or completely overlap and be in parallel.

The cover and the inner walls of the first and second container parts preferably form a channel which includes and thus covers any burr or thermoplastic material residue protruding inwardly from the inner perimeter of the welded rims. Preferably the cover and inner walls are shaped in such a way that under use conditions, for example when the container contains a pressurized liner bag, any burr or burr fragment that may be released, is retained in the channel so as to prevent puncturing or other damage to said liner bag.

In the assembly of the invention it is preferred, but not essential for the physical properties of the container or assembly, that the first or the second container part or both comprise a flange extending along an outer perimeter of the rim, said flange comprising a groove or chamber which extends along the outer perimeter of the rim for collection of thermoplastic material which protrudes from the welded rims outwardly, i.e., exterior burrs. This is desirable in order to provide on the outside a regular edge of the assembly in the joint region and may serve for fixing or attaching a further part onto the assembly.

In a preferred embodiment, the first or second container part or both are produced by injection molding. This has the advantage that it becomes possible to apply mass production of the container parts against relatively low costs. For those skilled in the art it is no problem to design the container parts such that the parts can easily be released from the mold and such that the injection molded container parts do not need any further machining. The container parts are being made out of thermoplastic materials such as for example polycarbonate, ABS (acrylonitrile-butadiene-styrene) copolymers, polyethylene, polypropylene or blends thereof. Preferred thermoplastic materials are polycarbonate, ABS or blends thereof.

The shapes of the rims of each container part are not critical provided that the rims substantially match in their circumference and are capable of being formed into a welded joint leaving substantially no gaps or cavities in the joint area. The surface areas of the rim can be in a curved or waved plane. In case of a surface area of the rim which is not flat or straight, the other rim preferably has a complementary surface area. In an even more preferred embodiment, each of the rims is substantially circle-shaped. Most preferably the surface of each of the rims lies in a plane. Such plane is preferably substantially perpendicular with respect to the rotational axis, if any, of the container part.

Moreover, one or both of the first and second container parts may be concave at the inner side. In a particular embodiment, the wall of the first container part and the wall of the second container part each comprise a hemisphere. This has the advantage that an optimum in the burst pressure of a container made of these parts is reached against minimum material costs.

Such hemispherical parts may be substantially hemispherical or may comprise a semi-spherical part of which the walls approaching or abutting the rim area extend linearly, thereby forming a cylindrical wall portion rather than have a continued concave shape.

For easy transport and/or positioning of a container made of these parts, the assembly may comprise one or more handles. At least one container part may comprises an opening for inserting a liner or liner bag into the container, for filling and emptying the container or such a liner or liner bag, and for applying an internal pressure by adding pressurized gas.

In a very practical embodiment the assembly is a container and further comprises a liner bag. This container is preferably suitable to withstand an internal pressure. The container provided with a liner bag is suitable for holding carbon dioxide containing liquids, such as lemonade, cola or beer.

In the method for fabricating a container preferably the rims of the first and second container parts are softened. The treatment may comprise hot plate welding or frictional welding. The welded joint is substantially in itself closed. The cover may comprises a first and a second cover part, wherein the first cover part is an integral part of the first container part and the second cover part is an integral part of the second container part. Alternatively, the cover comprises a separate part with respect to the joined first and second container parts. Another possibility is that the cover comprises an integral part of the first container part or the second container part. Other preferred embodiments of the method for fabricating a container are apparent for the skilled person from the description of the preferred embodiments of the assembly and container of the present invention and in the description of the figures.

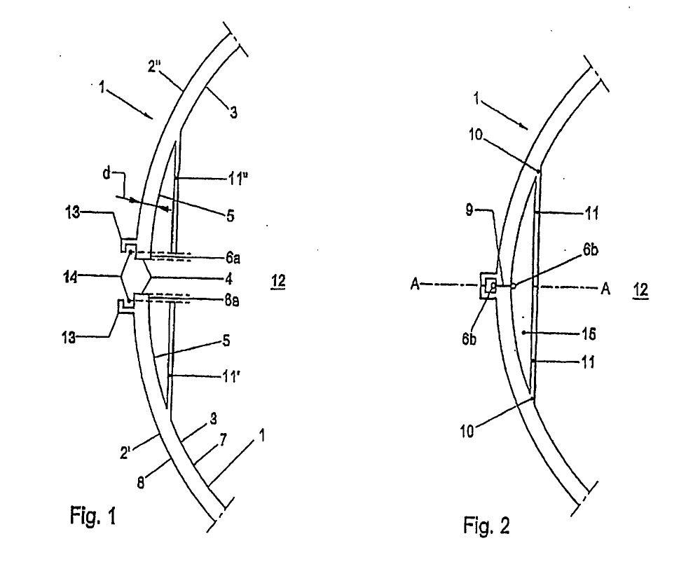

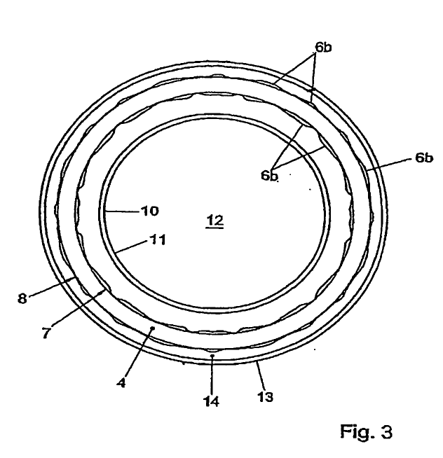

The invention is related to an assembly 1 of which a cross-section partly and schematically is shown in FIG. 1. The assembly comprises two container parts 2″, 2′ of thermoplastic material which both have a wall 3 and a rim 4 which is in itself closed. The dimensions of the parts 2″, 2′ are such that the rims 4 match each other. An inner side 5 of each wall 3 is concave near the rim 4. Instead of concave, the wall portion adjacent to the rim 4 may also be straight or slanted. Prior to joining or welding the container parts 2″, 2′, from both of the rims 4 an extra wall portion 6a of the thermoplastic material extends in alignment of the wall 3 near that rim 4. The extra wall portion 6a of the thermoplastic material extends parallel to and between an inner perimeter 7 and an outer perimeter 8 of the rim 4. The extra wall portion 6a is preferably as shown in FIG. 1, an extension across the full thickness d of the wall 3. During welding the extra wall portion 6a of thermoplastic material is softened and under pressure forms a joint 9 up to at least the inner perimeter 7. The excess of softened extra wall portion 6a of thermoplastic material which has flowed beyond the inner perimeter 7 or beyond the outer perimeter 8 and has solidified as an individual lump, is also known as a burr as shown as 6b in FIG. 2 and 3. To each inner side of the walls 3 is a cover connected along a closed line 10, shown in FIG. 2. In FIG. 1 and 2, the cover 11 is provided by the strip 11″ which forms an integral part of the container part 2″ and by the strip 11′ which forms an integral part of the container part 2′. Together these strips 11″, 11′ define the cover which, with the inner sides of the walls 3 of both container parts encloses the interior burr and shields an inner space 12 of the container from one or more interior burrs 6b of the thermoplastic material as shown in FIG. 2 and FIG. 3. Each strip 11″, 11′ extends along and within the inner perimeter 7 of the joined rims 4. In a plane A-A of the joined rims 4, as shown in FIG. 2 and in FIG. 3, each strip 11 is spatially separated from the joined rims 4. The strips 11 contact or nearly contact each other in or close to a plane A-A of the joined rims 4, as shown in FIG. 2. In other words, the cover as formed by these strips 11″, 11′ defines together with an inner side 5 of both walls 3 a channel 15, by which an inner space 12 of the container will be protected against burrs 6b. The continuous wall does not have cavities at or near the joint area over the perimeter of the joint and substantially maintains its thickness across the joint, thereby avoiding weak spots in the joint area.

The inner sides 5 of walls 3 of both container parts 2″, 2′ by themselves and thus without cover 11 or 11″, 11′ do not form a cavity near the rims 4. The rims 4 may have been joined by hot plate welding or another suitable technique. The rims 4 are in that case contacted with a hot plate, which is preferably circular or ring-shaped and fits against the rims 4. Once the extra wall portion 6a of thermoplastic material of at least one of the container parts becomes softened, the rims 4 are contacted with each other, applying some pressure. This welding method is applicable to rims in any form. Even contoured rims 4 which do not fit within one flat plane A-A can be welded using a plate or a ring (not shown) provided the plate or the ring follows the contours of the rim 4 or is at least capable of softening the extra wall portion 6a over substantially the whole rim surface.

As shown in FIG. 1 and FIG. 3, preferably a flange 13 extends along the outer perimeter 8 of the rim 4. This flange comprises a groove 14 which extends along the outer perimeter 8 of the rim 4 for collection of the residues of extra wall portion 6a of thermoplastic material which flowed outward during welding across the outer perimeter 8 of the matched rims 4 to form exterior burrs 6b. Collection and holding the burr 6b at the outer perimeter of the assembly is desirable, yet the design of such collection means is not critical for the invention and can take many different shapes.

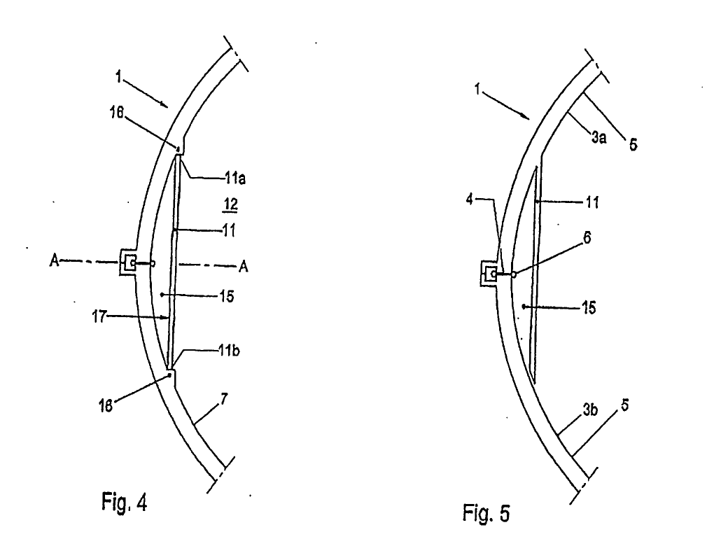

In another embodiment, as shown in FIG. 4 the assembly 1 comprises a strip 11 as a separate part. The strip has two peripheral edges 11a. This strip 11 is arranged to cover the inner perimeter 7 over the length of the joined rims 4 whilst one of the peripheral edges 11a contacts an inner side 5 of one of the walls 3 whilst the other peripheral edge 11a contacts or nearly contacts an inner side 5 of the other wall 3. The strip is in a plane A-A of the joined rims spatially separated from the joined rims 4. FIG.4 shows the positioning of the strip after the rims 4 are joined. In this case each inner side 5 of the walls 3 near the joined rims 4 comprises a shoulder 16 for fixing and support of the strip 11. This shoulder 16 may extend along the closed line 10 but may also be present in the form of separate, distinct shoulders on the inner side 5 of the walls 3. Instead of one or more shoulders 16, the strip 11 may also be positioned by one or more recesses (not shown). One wall 3 may comprise recesses while the other wall may comprise shoulders 16. The strip 11, which is, as shown in FIG. 4, a separate part of the assembly may be convex on the side 17 which faces the joined rims 4 to minimize the reduction of volume of the inner space 12. It is also possible that the side 17 of the separate strip 11 is straight or concave. If concave, it is possible to have the closed lines 10 much closer to the joined rims 4. The strip 11 is preferably close to the joined rims 4 as to minimize the reduction of the volume of the inner space 12 due to the presence of the strip 11. The channel 15 defined by any of the covers, i.e., provided as a separate cover or as integral part of one or more container parts, and an inner side 5 of the two container parts 2 or the two container parts 2″, 2′, preferably has a volume which is at least equal to the volume of the thermoplastic material protruding inwardly from the welded rims 4. The distance between the inside of the cover and the welded rims 4 is preferably between 0.5 d and 5 d, wherein d is the nominal thickness of the container parts 2 or the container parts 2″, 2′. For a skilled person it is easy to determine the amount of the extra wall portion 6a of thermoplastic material such that a strong joint will be created over the full thickness of the walls 3. The time the rims will need to be in contact with the hot plate, the temperature of the hot plate etc can all be experimentally determined. Equally, it will be easy to determine how much pressure should be applied during welding to minimize the amount of burr created by the softened extra wall portion 6a of thermoplastic material that will flow beyond the inner perimeter 7 and beyond the outer perimeter 8 of the joined rims 4 and to also ensure that the strips 11 touch, as shown in FIG. 2 or to make sure that the strip 11 is “locked in” as for instance shown in FIG. 4.

In FIG. 5 another example of a strip 11 is shown. This strip 11 extends along the joined rims 4 and is preferably an integral part of an inner side 5 of one wall 3a whilst almost touching or touching the inner side 5 of the other wall 3b. These rims 4 can be hot plate welded if the hot plate comprises the earlier mentioned ring which fits just against the rims 4. Alternatively, friction welding may be applied. If the rims 4 are circular, which they preferably are, also spin welding may be employed.

If the cover is an integral part of one or both of the container parts 2″, 2′ produced by injection molding, the angle enclosed by the cover and the tangent line to the wall 3 at the point where the cover is attached to the wall 3, is preferably between 5° and 25°, more preferably between 5° and 20°.

If the cover comprises one or more integral parts of the container parts 2″, 2′ produced by injection molding, the strip 11 or the strips 11″, 11′, are preferably in a tapered shape. This makes it easier to release the injection molded part from the mold.

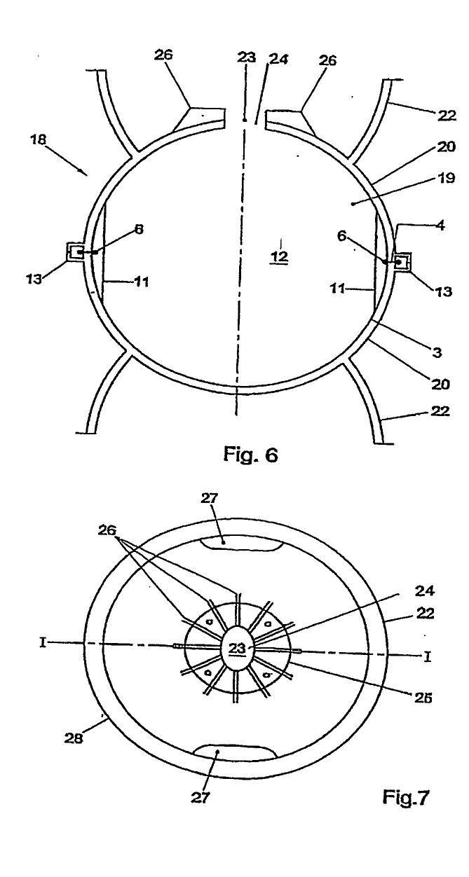

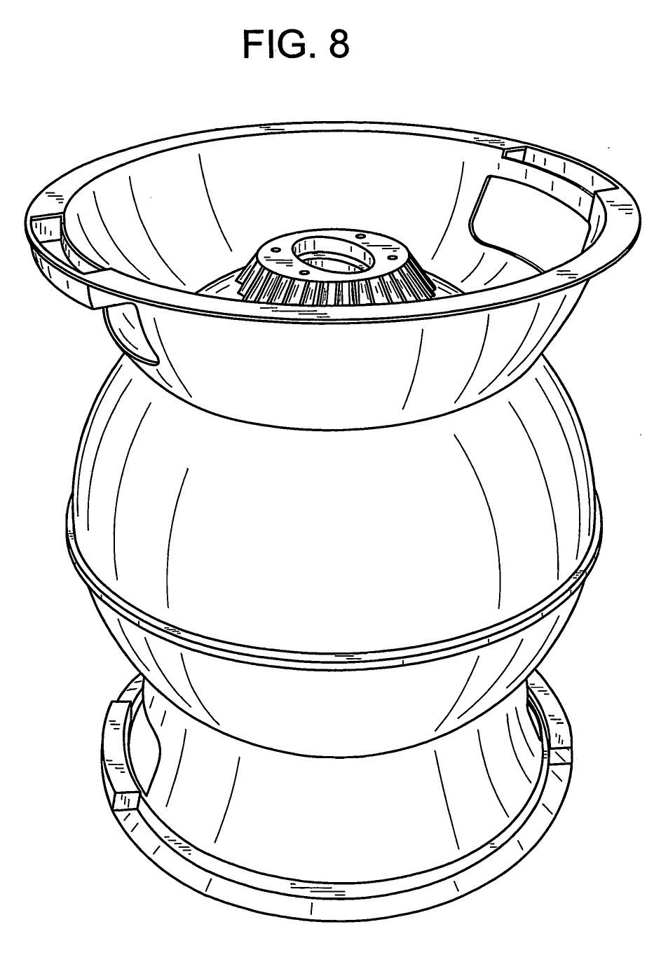

The rims 4 preferably comprise a circle. The container parts 2 generally are concave shaped, preferably each comprises a part of a sphere or even more preferably a hemisphere. FIG. 6 shows a cross-section along I-I in FIG. 7 of a container 18 with a high burst pressure and a high impact resistance. The inner space 12 comprises in this case essentially a sphere 19 to have minimum material costs. In a preferred mode, the container parts each comprise a hemisphere 20. The wall 3 of an outer side 21 of each container part 2 comprises in this example an annular sphere segment 22 which shares a rotational axis 23 with hemisphere 20. A smallest circumference of each annular sphere segment 22 adjoins the outer side of the container part 2. These container parts 2 can be injection molded, i.e. allowance can easily be provided for the necessary demolding angles. A container 18 of which a cross-section is shown in FIG. 6 can be rolled away, but can also be positioned and stocked such that rolling is resisted. During rolling the rotational axis 23 is kept parallel to the floor. The outer circumference 28 may be as large as the outer perimeter 8 of the joined rims 4, or larger so that rolling will occur in a straight line and rolling in an unintended direction is prevented.

FIG. 7 shows a top view of the container 18 of which a cross-section along I-I is shown in FIG. 6. The semi-sphere shown in this top view comprises an opening 24 around the rotational axis 23 for filling and emptying the container 18. The opening 24 is large enough to allow a liner bag (not shown) to be inserted. The liner bag can subsequently be filled with a liquid with or without dissolved gas and be pressurized. Due to the presence of the cover, in the form of one or two strips 11, the inner space, and in particular the liner bag, is shielded from interior burrs 6b of thermoplastic material which may otherwise cause a puncture leading to leaking of gas and/or liquids. The opening 24 is at the outer side surrounded by a ring 25 of ribs 26 to minimize a possible reduction of the burst pressure or impact resistance due to the presence of the opening 23. Each rib 26 extends from the ring 25 in a radial direction of the ring 25 towards the opening 24.

The opening 24 is preferably oval shaped. The oval shape provides a reduced open area in the container part as compared to a circular opening, allowing for an assembly which has increased burst pressure and impact strength properties. On the other hand an oval shape allows easier insertion of a folded liner bag than a circular opening of the same area. A valve (not shown) can be attached between the ring 25 and the oval opening 24 for securely closing the container 18. The annular sphere segment 22 as shown in the top view comprises further two handles 27 for manually handling or positioning the container 18. The container 18 can also be produced without handles. In that case, separate handles may be used for manual transport.

The two container parts 2 which are in FIG. 6 shown as joined can both be injection molded and then be joined by the welding methods as discussed above.

The wall 3 between the rim 4 and a concave part of the wall 3 may be cylindrical. It is in that case possible to enhance the volume of the container 18 without having to enhance the diameter of the rims 4.

Further advantages of a container according to the present invention include the following. The container of thermoplastic material is light compared to the well known steel or aluminum containers. Clanging occurring as a result of collision of the containers 18 or stacking of the container 18 will be minimal. Wear and tear on floors over which the containers 18 are rolled and positioned will be less compared to the wear and tear occurring when metal containers are used. The container is therefore easier to handle and a saving in transport costs of these containers may be achieved. The containers can be employed in combination with an interchangeable liner bag which is suitable for containing liquids and/or pressurized gas. The containers can in that case easily be employed for storage and transport of beer which can be dispensed with simply compressed air, carbon dioxide or mixed gas. However, also wine, mineral water, juices and possibly even certain chemicals can be kept in this type of container. The container made of thermoplastic material can be transparent so that one can see how much of the container is filled. Logo's, names, indications of the volumes etc. can easily be incorporated on the outer side of the container.

Although embodiments of the present invention have been described in detail herein, it is to be understood that this invention is not limited to these precise embodiments and that modifications and variations may be effected therein by one skilled in the art without departing from the scope of the invention as defined by the appended claims.

1. An assembly comprising at least a first and a second container part each comprising a thermoplastic material, wherein the first container part and the second container part are joined, wherein the first container part and the second container part each comprises a wall and a rim which rim is substantially closed in itself, wherein the rim of the first container part and the rim of the second container part are welded against each other, wherein the assembly further comprises a cover which defines together with an inner side of the wall of the first container part and an inner side of the wall of the second container part a channel for protection of an inner space of the joined first container part and second container part against thermoplastic material that may protrude from the welded rims, wherein the inner side of the wall of the first container part and the inner side of the wall of the second container part by themselves and without the cover do not define a cavity near the rims.

2. The assembly according to claim 1, wherein the cover comprises a separate part with respect to the joined first and second container parts.

3. The assembly according to claim 2, wherein the separate part comprises one strip with two peripheral edges, wherein at least one of the peripheral edges is in contact with an inner side of the wall of the first or second container part.

4. The assembly according to claim 3, wherein at least one wall of the first and second container parts comprises a shoulder or recess for support of the strip.

5. The assembly according to claim 1, wherein the cover comprises an integral part of the first container part or of the second container part.

6. The assembly according to claim 5, wherein the integral part comprises a strip.

7. The assembly according to claim 1, wherein the cover comprises a first and a second cover part wherein the first cover part is an integral part of the first container part and the second cover part is an integral part of the second container part.

8. The assembly according to claim 7, wherein the first part comprises a first strip and the second part comprises a second strip.

9. The assembly according to claim 8, wherein the first and the second strip contact or nearly contact each other.

10. The assembly according to claim 1, wherein the first, the second, or both container parts comprise a flange extending along an outer perimeter of the rim, said flange comprising a groove which extends along the outer perimeter of the rim for collection of thermoplastic material which protrudes from the welded rims outwardly.

11. The assembly according to claim 1, wherein at least one of the first and second container parts is produced by injection molding.

12. The assembly according to claim 1, wherein each of the rims is substantially circle-shaped.

13. The assembly according to claim 1, wherein at least one of the first and second container parts is concave at the inner side.

14. The assembly according to claim 13, wherein the wall of the first container part and the wall of the second container part each comprise a semi-sphere.

15. The assembly according to claim 1, wherein the assembly comprises at least one handle.

16. The assembly according to claim 1, wherein at least one container part comprises at least one opening.

17. The assembly according to claim 1, wherein the assembly is a container and further comprises a liner bag.

18. A container according to claim 17, wherein the container is suitable for holding carbon dioxide containing liquids.

19. A container according to claim 18, suitable to withstand an internal pressure.

20. (cancelled).

21. A method for fabricating a container comprising the steps of:
providing a first container part and a second container part each comprising thermoplastic material and each comprising a wall and a rim which is substantially closed in itself and providing a cover;
subjecting at least one rim of the first container part or the second container part to a treatment to soften thermoplastic material at the rim;
arranging the first container part and the second container part such that the rim of the first container part and the rim of the second container part contact each other while the thermoplastic material at least one rim is softened and while the cover is in contact with at least an inner side of a wall of the first or second container part;
applying pressure so that the rim of the first container part and the rim of the second container part are pressed together to form a joint, wherein softened thermoplastic material is squeezed inwardly from the welded joint into a channel defined by the cover and the inner side of the wall of the first container part and the wall of the second container part, wherein the inner side of the wall of the first container part and the inner side of the wall of the second container part by themselves and without the cover do not define a cavity near the rims.

22. The method according to claim 21, wherein both the rims are softened.

23. The method according to claim 21, wherein the heat treatment comprises hot plate welding or frictional welding.

24. The method according to claim 21, wherein the welded joint is in itself substantially closed.

25. The method according to claim 21, wherein the cover comprises a first and a second cover part, wherein the first cover part is an integral part of the first container part and the second cover part is an integral part of the second container part.
